(19) United States
(12) Patent Application Publication
(10) Pub. No.: US 2009/0165824 A1
(43) Pub. Date: Jul. 2, 2009

(54) Cleaning apparatus for cleaning component part of magnetic disk drive and cleaning method of cleaning component part of magnetic disk drive

(75) Inventors: Kazuya Sekiguchi, Kanagawa (JP); Hiroyuki Sugimoto, Kanagawa (JP); Hirokazu Yamamoto, Kanagawa (JP); Akiko Hashi, Kanagawa (JP); Katsuhiro Ota, Kanagawa (JP); Mieko Kashi, Kanagawa (JP); Toshinori Jinoka, Kanagawa (JP); Takuya Kambayashi, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Strorage Technologies Netherlands B.V., Amsterdam (NL)

(21) Appl. No.: 12/316,749

(22) Filed: Dec. 15, 2008

(30) Foreign Application Priority Data
Dec. 26, 2007 (JP) 2007-334809

(51) Int. Cl. B08B 3/00; B08B 3/02; B08B 3/04; B08B 3/12; B08B 3/08; B08B 5/04

(52) U.S. Cl. 134/21; 134/61; 134/73; 134/68; 134/63

(57) ABSTRACT

Embodiments of the present invention improve the efficiency of a cleaning process for cleaning a component part of a magnetic disk drive in a magnetic disk drive manufacturing line. According to one embodiment, a magnetic disk part cleaning apparatus is included in a head stack assembly (HSA) cleaning line for cleaning head stack assemblies of magnetic disk drives included in a magnetic disk drive manufacturing line. The magnetic disk part cleaning apparatus is disposed between a HSA assembly line for assembling a head stack assembly, and head disk assembly (HDA) assembly line for assembling a head disk assembly including the head stack assembly and is connected directly to at least either of the HSA assembly line and the HDA assembly line.

### CROSS-REFERENCE TO RELATED APPLICATION

The instant nonprovisional patent application claims priority to Japanese Patent Application No. 2007-334809 filed Dec. 26, 2007 and which is incorporated by reference in its entirety herein for all purposes.

### BACKGROUND OF THE INVENTION

Techniques for cleaning a component part of a precision device, such as a magnetic disk drive disclosed in Japanese Patent Publication No. H6-120197 and Japanese Patent Publication No. H7-171525, clean the parts in a tank containing a solvent by an ultrasonic cleaning process.

Cost reduction of magnetic disk drives has been requested in recent years and production of magnetic disk drives at a high productivity is desired. Efficiently carrying out a cleaning process for cleaning a component part of a magnetic disk drive, namely, one of magnetic disk drive manufacturing processes, and curtailment of the processing time of the cleaning process have become awaiting problems.

A conventional cleaning line for cleaning a component part of a magnetic disk drive, such as head stack assemblies, is not directly connected to a manufacturing line for manufacturing magnetic disk drives. Moreover, a manufacturing line designed so as to include a cleaning line for carrying out a cleaning process is not necessarily efficient.

### BRIEF SUMMARY OF THE INVENTION

Embodiments of the present invention help to improve the efficiency of a cleaning process for cleaning a component part of a magnetic disk drive in a magnetic disk drive manufacturing line. According to the embodiment of FIG. 2, a magnetic disk part cleaning apparatus 10 is included in a head stack assembly (HSA) cleaning line 2 for cleaning head stack assemblies of magnetic disk drives included in a magnetic disk drive manufacturing line. The magnetic disk part cleaning apparatus 10 is disposed between a HSA assembly line 1 for assembling a head stack assembly and head disk assembly (HDA) assembly line 3 for assembling a head disk assembly including the head stack assembly and is connected directly to at least either of the HSA assembly line 1 and the HDA assembly line 3.

### BRIEF DESCRIPTION OF THE DRAWINGS

FIG. 1 is a view of a part of a magnetic disk drive manufacturing line including a magnetic disk part cleaning apparatus according to an embodiment of the present invention.

FIG. 2 is a schematic view showing the construction of a magnetic disk part cleaning apparatus in a first embodiment of the present invention.

FIG. 3 is a schematic view showing the construction of a magnetic disk part cleaning apparatus in a second embodiment of the present invention.

FIG. 4 is a schematic view showing the construction of a magnetic disk part cleaning apparatus in a third embodiment of the present invention.

FIGS. 5(A) and 5(B) are schematic views of a magnetic disk part cleaning apparatus in a fourth embodiment of the present invention.

FIG. 6 is a schematic view of assistance in explaining a magnetic disk part cleaning apparatus in a fifth embodiment of the present invention.

FIG. 7 is a flow chart of a magnetic disk drive part cleaning process in a sixth embodiment of the present invention.

FIG. 8 is a schematic view of assistance in explaining the construction of a magnetic disk part cleaning apparatus in the sixth embodiment.

### DETAILED DESCRIPTION OF THE INVENTION

Embodiments of the present invention relate to a cleaning apparatus for cleaning a component part of a magnetic disk drive, and a cleaning method of cleaning a component part of a magnetic disk drive.

Embodiments of the present invention have been made in view of the foregoing, and it is therefore an object of embodiments of the present invention to provide a cleaning apparatus for cleaning a component part of a magnetic disk drive, capable of operating efficiently when a cleaning process for cleaning a component part of a magnetic-disk drive is incorporated into a magnetic disk drive manufacturing line, and a cleaning method of cleaning a component part of a magnetic disk drive.

A cleaning apparatus in a first aspect of embodiments of the present invention for cleaning a component part of a magnetic disk drive, is incorporated into a magnetic disk drive manufacturing line to clean a head stack assembly included in a magnetic disk drive, is disposed between a first assembly line for assembling the head stack assembly and a second assembly line for assembling a head disk assembly including the head stack assembly, and is directly connected to at least either of the first and the second assembly line.

According to a second aspect of embodiments of the present invention the cleaning apparatus for cleaning a component part of a magnetic disk drive includes: a cleaning unit for cleaning the head stack assembly with a predetermined cleaning liquid; a drying unit for drying the head stack assembly cleaned by the cleaning unit; and a carrying means for carrying the head stack assembly to the cleaning unit and the drying unit.

According to a third aspect of embodiments of the present invention, in the cleaning apparatus for cleaning a component part of a magnetic disk drive, the cleaning unit includes a first cleaning unit for spraying a predetermined cleaning liquid on the head stack assembly, and a second cleaning unit for cleaning the head stack assembly by immersing the head stack assembly in a predetermined cleaning liquid contained in a cleaning tank, the carrying means carries the head stack assembly to the first cleaning unit, the second cleaning unit and the drying unit.

According to a fourth aspect of embodiments of the present invention, in the cleaning apparatus for cleaning a component part of a magnetic disk drive, the head stack assembly is dried while the carrying means carries the same.

According to a fifth aspect of embodiments of the present invention, the cleaning apparatus for cleaning a component part of a magnetic disk drive further includes an arm for picking up a head stack assembly delivered from the first assembly line and for vertically moving the picked-up head stack assembly; wherein the first and the second cleaning unit are disposed close to each other with respect to a horizontal direction, the picked-up head stack assembly is carried by the carrying means and the arm to the first and the second cleaning unit, and the dried head stack assembly is delivered to the second assembly line.

According to a sixth aspect of embodiments of the present invention, the cleaning apparatus for cleaning a component part of a magnetic disk drive further includes a rotary mechanism for holding at least one of the head stack assemblies and for turning the head stack assembly held by the rotary mechanism about a vertical axis passing a predetermined support position, wherein the first cleaning unit, the second cleaning unit and the drying unit are arranged along a turning route along which the rotary mechanism turns, and the carrying means carries the head stack assembly to the first cleaning unit, the second cleaning unit and the drying unit by turning the rotary mechanism.

According to a seventh aspect of embodiments of the present invention, in the cleaning apparatus for cleaning a component part of the magnetic disk drive, the carrying means includes a belt conveyor for carrying the head stack assembly to the first cleaning unit, the second cleaning unit and the drying unit.

According to an eighth aspect of embodiments of the present invention, the cleaning apparatus for cleaning a component part of a magnetic disk drive further includes a rotary mechanism for holding the plural head stack assemblies and for turning the head stack assemblies held thereby about a predetermined position in a predetermined direction, wherein the second cleaning unit cleans the plural bead stack assemblies simultaneously by turning the rotary mechanism, and the drying unit dries the plural head stack assemblies simultaneously by turning the rotary mechanism.

According to a ninth aspect of embodiments of the present invention, in the cleaning apparatus for cleaning a component part of the magnetic disk drive, a looped carrying route is formed so as to pass the first cleaning unit, the second cleaning unit and the drying unit sequentially.

According to a tenth aspect of embodiments of the present invention, in the cleaning apparatus for cleaning a component part of a magnetic disk drive, the predetermined cleaning liquid is an organic solvent.

According to an eleventh aspect of embodiments of the present invention, in the cleaning apparatus for cleaning a component part of the magnetic disk drive, the organic solvent is a fluorocarbon solvent.

According to a twelfth aspect of embodiments of the present invention, in the cleaning apparatus for cleaning a component part of the magnetic disk drive, the first cleaning unit pressurizes the predetermined cleaning liquid, and sprays the pressurized cleaning liquid on a predetermined part of the head stack assembly for cleaning.

According to a thirteenth aspect of embodiments of the present invention, in the cleaning apparatus for cleaning a component part of a magnetic disk drive, the cleaning tank is provided with an ultrasonic vibrator, and the second cleaning unit cleans the head stack assembly by an ultrasonic cleaning process using the ultrasonic vibrator.

According to a fourteenth aspect of embodiments of the present invention, in the cleaning apparatus for cleaning a component part of a magnetic disk drive, the cleaning unit has an open upper end, and the cleaning apparatus for cleaning a component part of a magnetic disk drive is an open structure.

According to a fifteenth aspect of embodiments of the present invention, the cleaning apparatus for cleaning a component part of a magnetic disk drive further includes a cleaning liquid recovering means for recovering the predetermined cleaning liquid evaporated in the cleaning apparatus for cleaning a component part of a magnetic disk drive, and replenishing the cleaning unit with the recovered cleaning liquid.

According to a sixteenth aspect of embodiments of the present invention, a cleaning method of cleaning a component part of a magnetic disk drive, includes the steps of: carrying a head stack assembly into a cleaning unit and sealing the cleaning unit, evacuating the sealed cleaning unit, cleaning the head stack assembly with a predetermined cleaning liquid containing an organic solvent in the evacuated cleaning unit, carrying the cleaned head stack assembly into a drying unit and sealing the drying unit; evacuating the sealed drying unit, and drying the head stack assembly in the evacuated drying unit.

According to embodiments of the present invention, production efficiency can be improved by incorporating the cleaning process for cleaning the component part (head stack assembly) of a magnetic disk drive into the magnetic disk drive manufacturing line. According to embodiments of the present invention, the efficiency of the cleaning process incorporated into the manufacturing line can be improved.

Particular embodiments (hereinafter, referred to simply as “embodiments”) of the present invention will be described with reference to the accompanying drawings.

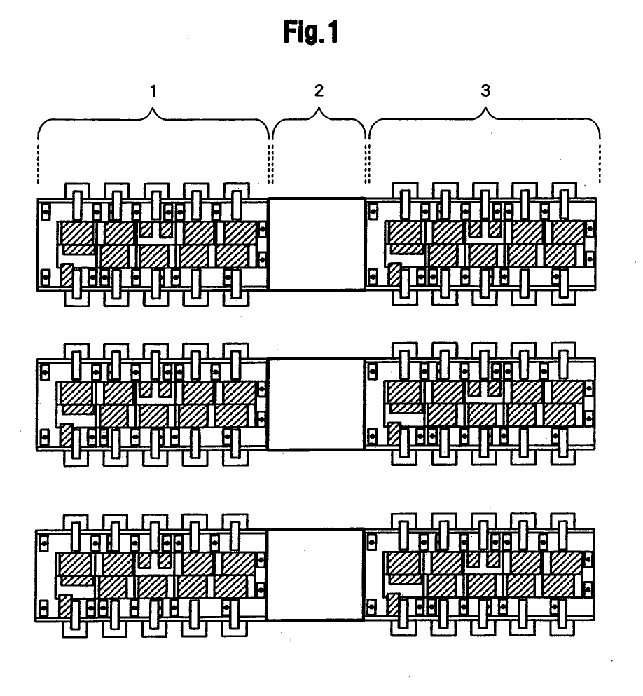

FIG. 1 shows a part of a magnetic disk drive manufacturing line including a cleaning apparatus for cleaning a component part of a magnetic disk drive (hereinafter, referred to as “magnetic disk drive part cleaning apparatus”) in the embodiments. The magnetic disk drive manufacturing line shown in FIG. 1 includes a HSA assembly line 1 for assembling a head stack assembly (abbreviated to HSA), a cleaning line 2 for cleaning an assembled HSA, and a HDA assembly line 3 for assembling a head disk assembly (abbreviated to HDA) using a cleaned HSA.

The HSA assembly line 1 assembles component parts of a HSA including a VCM coil, a head gimbals assembly, a bearing unit, and FPC into a HSA.

The HSA cleaning line 2 cleans a HSA assembled by the HSA assembly line 1. The HSA cleaning line 2 is directly connected to the HSA assembly line 1. The HSA assembled by the HSA assembly line 1 is carried to the HSA cleaning line 2. The HSA cleaning line 2 is directly connected also to the HDA assembly line 3. A HSA cleaned by the HSA cleaning line 2 is carried to the HDA assembly line 3. The magnetic disk part cleaning apparatus embodying the present invention cleans a HSA. A cleaning process and the magnetic disk part cleaning apparatus will be described later.

The HDA assembly line 3 assembles component parts including a cleaned HSA, a magnetic disk, a disk fixing mechanism, a voice coil motor and a stopper into a HDA.

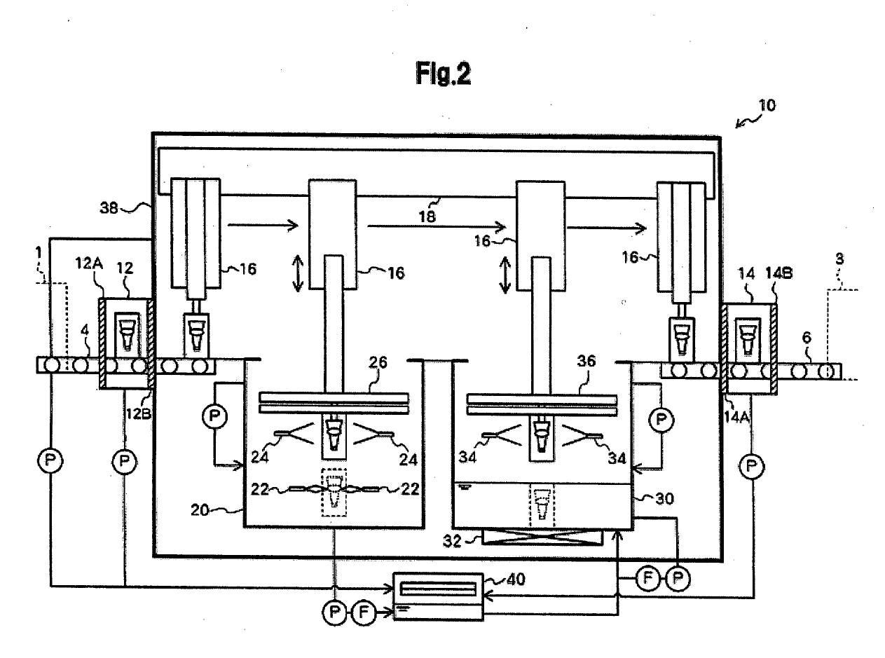

FIG. 2 shows a magnetic disk part cleaning apparatus 10 in a first embodiment of the present invention. As shown in FIG. 2, the magnetic disk part cleaning apparatus 10 is directly connected to the HSA assembly line 1 and the HDA assembly line 3. The magnetic disk part cleaning apparatus 10 cleans a HSA while the HSA is being carried from the HSA assembly line 1 through the magnetic disk part cleaning apparatus 10 to the HDA assembly line 3. A HSA cleaning process to be carried out by the magnetic disk part cleaning apparatus 10 will be described.

A conveyor belt 4 supports a HSA assembled by the HSA assembly line 1 thereon and carries the HSA toward the magnetic disk part cleaning apparatus 10. Upon the arrival of the HSA at a receiving unit 12 provided with two doors 12A and 12B, the door 12A on the side of the HSA assembly line 1 is opened to receive the HSA in the receiving unit 12. Then, the door 12A is closed, the door 12B on the side of the magnetic disk part cleaning apparatus 10 is opened and the HSA is carried into the magnetic disk part cleaning apparatus 10.

The HSA carried into the magnetic disk part cleaning apparatus 10 is picked up by an arm 16. The arm 16 has a telescopic mechanism and can be moved vertically and horizontally by a carrying mechanism 18 for carrying a base to which the arm 16 is attached. The arm 16 moves the HSA horizontally to a position above a spray cleaning tank 20. Then, the arm 16 extends downward to locate the HSA at a predetermined position where a pressurized spray unit 22 is disposed.

The pressurized spray unit 22 sprays a pressurized cleaning liquid on the HSA fixedly held by the arm 16 for local cleaning. Parts of the HSA cleaned by the local cleaning may be, for example, a mold, soldered parts and such. The cleaning liquid may be a highly volatile organic solvent, such as hydrofluoroether (HFE). A process time required for completing a HSA drying process can be reduced by using the highly volatile organic solvent as the cleaning liquid. The cleaning liquid may be a mixture of some kinds of organic solvents or a mixture of an organic solvent and an aqueous cleaning liquid.

The arm 16 moves the spray-cleaned HSA to a hot-air drying unit 24 disposed above the pressurized cleaning unit 22. The hot-air drying unit 24 blows heated, compressed dry air on the HSA to remove the cleaning liquid adhering to the HSA and to dry the HSA. There is not particular limit to the temperature of the heated, compressed dry air used by the hot-air drying unit 24. After the HSA has been dried by the hot-air drying unit 24, the arm 16 and the carrying mechanism 18 carry the HSA to an ultrasonic cleaning tank 30. The time needed by the arm 16 to carry the HSA can be used as a drying time.

The arm 16 immerses the HSA in a cleaning liquid contained in the ultrasonic cleaning tank 30 for ultrasonic cleaning. As mentioned above, the cleaning liquid may be an organic solvent, such as HFE. An ultrasonic vibrator 32 combined with the ultrasonic cleaning tank 30 operates to carry out ultrasonic cleaning. After the completion of ultrasonic cleaning, the arm 16 transfers the HSA to a hot-air drying unit 34 disposed above the ultrasonic cleaning tank 30.

The hot-air drying unit 34 blows heated, compressed dry air on the HSA to remove the cleaning liquid adhering to the HSA and to dry the HSA. The vapor of the cleaning liquid contained in the ultrasonic cleaning tank 30 is reduced to the cleaning liquid by a cooling coil 36, and the liquefied cooling liquid is recovered. After the HSA has been dried, the arm 16 transfers the HSA onto a conveyor belt 6 connected to the HDA assembly line 3.

Upon the arrival of the HSA placed on the conveyor belt 6 at a delivery unit 14 provided with two opposite doors 14A and 14B, the door 14A on the side of the magnetic disk part cleaning apparatus 10 is opened to receive the HSA in the delivery unit 14. After the HSA has been received in the delivery unit 14, the door 14A is closed, the door 14B on the side of the HDA assembly line 3 is opened, and the HSA is delivered to the HDA assembly line 3.

The spray cleaning tank 20 and the ultrasonic cleaning tank 30 have open upper ends, respectively, to receive the HSA therein. A cooling coil 26 and the cooling coil 36 liquefy the vaporized organic solvent to prevent the vapor of the organic solvent from leaking from the spray cleaning tank 20 and the ultrasonic cleaning tank 30. However, the leakage of the vapor of the organic solvent cannot be completely prevented by those arrangements. The receiving unit 12, the delivery unit 14, the spray cleaning tank 20 and the ultrasonic cleaning tank 30 of the magnetic disk part cleaning apparatus 10, and a cover 38 covering the magnetic disk part cleaning apparatus 10 is provided with pumps, respectively, to suck and recover the vaporized organic solvent. The organic solvent sucked by the pumps is stored temporarily in a distillation tank 40. The recovered organic solvent stored in the distillation tank 40 is supplied to the pressurized spray unit 22 and the ultrasonic cleaning tank 30.

The magnetic disk part cleaning apparatus 10 in the first embodiment that carries out a HSA cleaning process between a HSA assembly process and a HDA assembly process can improve the efficiency of magnetic disk drive production. The magnetic disk part cleaning apparatus 10 cleans and dries the HSA while the HSA is being carried and uses the highly volatile organic solvent as the cleaning liquid. Therefore, a predetermined time for the line takt of the HSA cleaning process can be reduced to a desired process time on the order of 5 s or below. Cleaning specific parts of the HSA with the pressurized spray, especially locally cleaning the parts required to be precisely cleaned or parts difficult to clean can improve cleaning accuracy. The magnetic disk part cleaning apparatus 10 is formed in a highly airtight structure and the vaporized organic solvent is recovered and the recovered organic solvent is circulated in the magnetic disk part cleaning apparatus 10. Thus, the highly volatile organic solvent can be efficiently used and the consumption of the organic solvent can be suppressed.

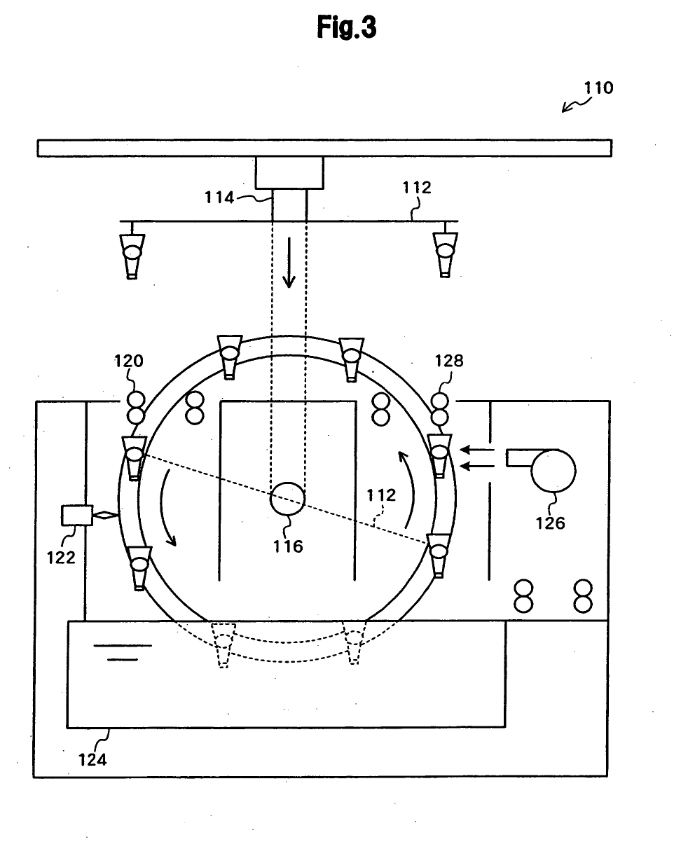

A magnetic disk part cleaning apparatus 110 in a second embodiment of the present invention will be described with reference to FIG. 3 showing the construction of the magnetic disk part cleaning apparatus 110 in the second embodiment. In FIG. 3, the joint of the magnetic disk part cleaning apparatus 110 and the HSA assembly line 1 and the joint of the magnetic disk part cleaning apparatus 110 and the HDA assembling line 3 are omitted. The magnetic disk part cleaning apparatus 110 in the second embodiment may be directly connected to those assembly lines.

As shown in FIG. 3, the magnetic disk part cleaning apparatus 110 in the second embodiment has a rotary mechanism 112 capable of turning about a vertical axis. HSAs delivered from the HSA assembly line 1 are held on the opposite ends of the rotary mechanism 112, respectively. The distance between the opposite ends of the rotary mechanism 112 may be, for example, on the order of 600 mm. A support member 114 supporting the rotary mechanism 112 moves the rotary mechanism 112 vertically downward to a predetermined position 116. Upon the arrival of the rotary mechanism 112 at the predetermined position 116, the rotary mechanism 112 holding the HSAs starts turning about the predetermined position 116.

In the magnetic disk part cleaning apparatus 110, a cooling coil 120, a pressurized spraying unit 122, an ultrasonic cleaning tank 124, a hot-air drying unit 126 and a cooling coil 128 are arranged counterclockwise in that order along a turning route along which the rotary mechanism 112 turns. The rotary mechanism 112 holding the HSAs turns counterclockwise about the predetermined position 116 to subject the HSAs sequentially to a series of processes, namely, a local cleaning process by the pressurized spraying unit 122, a cleaning process for cleaning the HSA in the ultrasonic cleaning tank 124 and a drying process for drying the HSA by the hot-air drying unit 126. The cooling coils 120 and 128 disposed in an open space cool cleaning liquid vapor filling the magnetic disk part cleaning apparatus 110 and recover the liquefied cleaning liquid to prevent loss of the organic solvent by volatilization.

The magnetic disk part cleaning apparatus 110 in the second embodiment can reduce the line takt of the HSA cleaning process, can improve cleaning efficiency and can be installed in a reduced floor space.

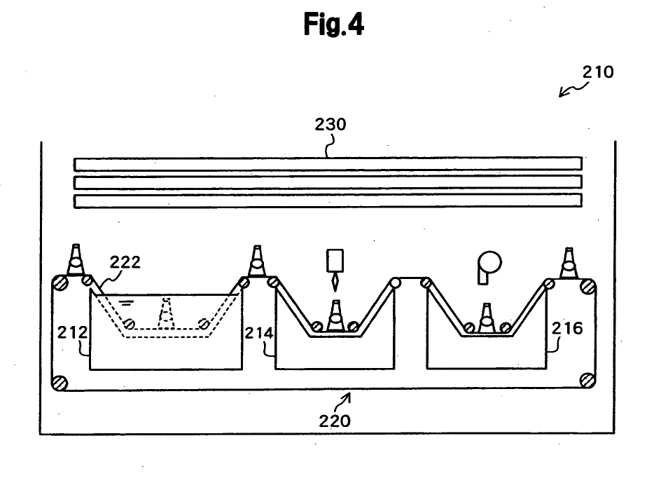

A magnetic disk part cleaning apparatus 210 in a third embodiment of the present invention will be described with reference to FIG. 4 showing the construction of the magnetic disk part cleaning apparatus 210 in the third embodiment. In FIG. 4, the joint of the magnetic disk part cleaning apparatus 210 and the HSA assembly line 1 and the joint of the magnetic disk part cleaning apparatus 210 and the HDA assembly line 3 are omitted. The magnetic disk part cleaning apparatus 210 in the third embodiment may be directly connected to those assembly lines.

As shown in FIG. 4, the magnetic disk part cleaning apparatus 210 in the third embodiment includes a belt conveyor 220 passing a ultrasonic cleaning tank 212, a spray cleaning tank 214 and a hot-air drying tank 216 in that order. The belt conveyor 220 has a belt 222 that turns clockwise to carry a HSA placed thereon to the ultrasonic cleaning tank 212, the spray cleaning tank 214 and the hot-air drying tank 216 in that order. A cooling coil 230 is disposed above the belt conveyor 220. The cooling coil 230 liquefies the vapor of a cleaning liquid to recover the cleaning liquid and to prevent loss of an organic solvent by volatilization.

The magnetic disk part cleaning apparatus 210 in the third embodiment is simple in construction and facilitates continuously cleaning the HSA and can improve the efficiency of a cleaning process.

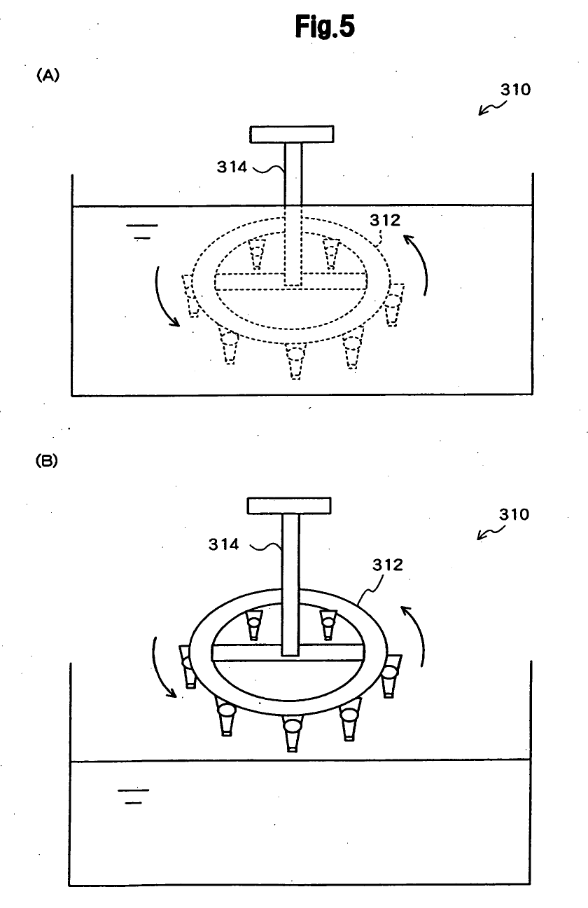

A magnetic disk part cleaning apparatus 310 in a fourth embodiment of the present invention will be described with reference to FIGS. 5(A) and 5(B) showing the typical characteristic construction of the magnetic disk part cleaning apparatus 310 in the fourth embodiment.

As shown in FIGS. 5(A) and 5(B), the magnetic disk part cleaning apparatus 310 in the fourth embodiment is provided with an annular rotary member 312 capable of holding plural HSAs. As shown in FIG. 5(A), the annular rotary member 312 holding plural HSAs is immersed in an organic solvent contained in a cleaning tank, and then a rotary shaft 314 attached to the annular rotary member 312 is rotated to revolve the HSAs simultaneously for rotational cleaning. After the HSAs have been cleaned, the annular rotary member 312 is raised up from the cleaning tank as shown in FIG. 5(B). Then the rotary member 312 is rotated to revolve the HSAs simultaneously for rotational drying.

The magnetic disk part cleaning apparatus 310 in the fourth embodiment capable of simultaneously cleaning and drying the plural HSAs can improve the efficiency of the cleaning process. Rotational drying can achieve efficient drying as well as hot-air drying.

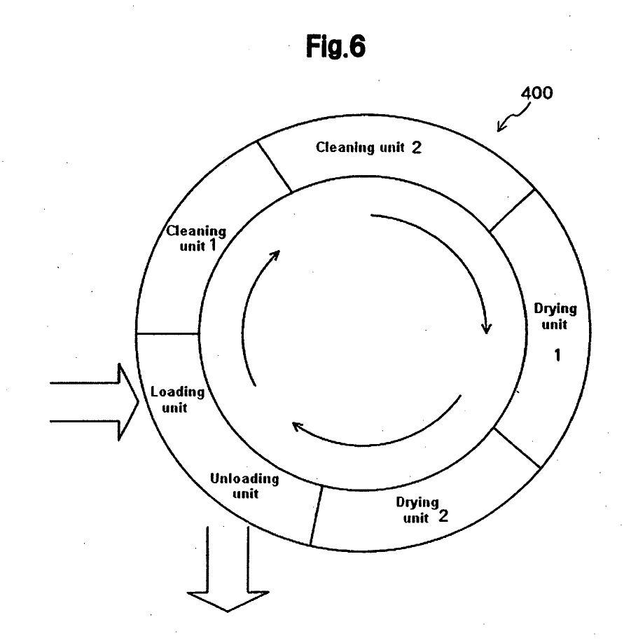

A magnetic disk part cleaning apparatus in a fifth embodiment of the present invention will be described with reference to FIG. 6 typically showing a characteristic carrying passage for a cleaning process 400.

In the magnetic disk part cleaning apparatus 10 in the first embodiment, the HSA is carried linearly from the receiving unit 12 to the delivery unit 14 apart from the receiving unit 12. In the magnetic disk part cleaning apparatus in the fifth embodiment, the carrying passage for the cleaning process is formed in a loop as shown in FIG. 6, and a receiving unit and a delivery unit are at the same position or are disposed adjacently. Thus, the magnetic disk part cleaning apparatus can be installed in a narrow floor space, and the flexibility of the disposition of the magnetic disk part cleaning apparatus can be improved.

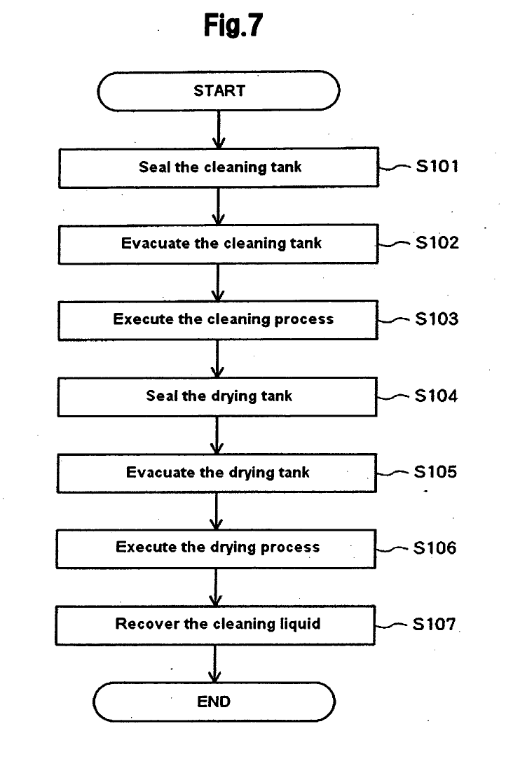

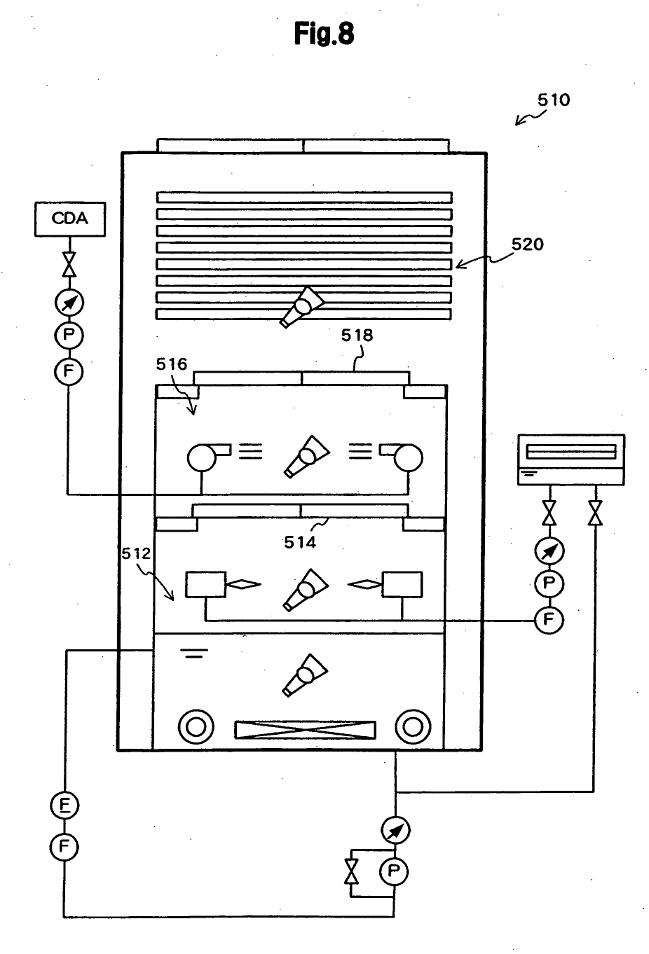

A HSA cleaning process in a sixth embodiment of the present invention will be described with reference to FIGS. 7 and 8. This cleaning process closes processing tanks separately for cleaning and drying to carry out the cleaning process efficiently. FIG. 7 is a flow chart of the cleaning process and FIG. 8 is a schematic view of a magnetic disk part cleaning apparatus 510 for cleaning a HSA by the cleaning process.

First, a HSA is carried into a cleaning tank 512, and then a sealing shutter 514 is closed to seal the cleaning tank 512 (S101). The cleaning tank 512 is evacuated to a pressure between 0.1 and 10 kPa (S102), and then ultrasonic cleaning and spray cleaning are carried out (S103). This embodiment, similarly to the foregoing embodiments, uses an organic solvent that can be dried highly efficiently as a cleaning liquid. Then, the sealing shutter 514 is opened, the cleaned HSA is transferred to a drying tank 516, and then the sealing shutter 514 and a sealing shutter 518 are closed to seal the drying tank (S104). Then, the drying tank 516 is evacuated to a pressure between 0.1 and 10 kPa (S105) to dry the HSA rapidly (S106). The drying speed of a drying process may be enhanced by blowing dry compressed air against the HSA. After the HSA has been dried in the drying tank 516, the closing shutter 518 is opened to set the drying tank 516 at the atmospheric pressure, a cooling coil 520 is moved to liquefy the vapor of the cleaning liquid contained in the drying tank 516 and to recover the evaporated cleaning liquid (S107). A pressurizing gas for setting the interior of the drying tank 516 at the atmospheric pressure may be air or an inert gas, such as nitrogen gas, He gas or Ar gas.

The magnetic disk drive part cleaning method in the sixth embodiment and the magnetic disk part cleaning apparatus 510 seal the processing tanks separately. Thus the processes can be carried out simultaneously respectively in the processing tanks and can reduce loss of the highly volatile organic solvent by volatilization. The HSA can be rapidly dried by evacuating the sealed drying tank 516 for drying the HSA by drying under a reduced pressure. Since the processing tanks of the magnetic disk part cleaning apparatus 510 are arranged vertically, the magnetic disk part cleaning apparatus 510 can be installed in a narrow floor space.

The present invention is not limited in its practical application to the foregoing embodiments. Although the magnetic disk part cleaning apparatus is connected directly to both the HSA assembly line and the HDA assembly line 3 in the foregoing embodiments, the magnetic disk part cleaning apparatus may be connected directly to either of the HSA assembly line and the HDA assembly line 3. The magnetic disk part cleaning apparatus may be formed in open construction. It is obvious to those skilled in the art that various changes and variations are possible in the foregoing embodiments specifically described herein without departing from the scope and spirit of the invention.

What is claimed is:

1. A cleaning apparatus incorporated into a magnetic disk drive manufacturing line to clean a head stack assembly included in a magnetic disk drive, the cleaning apparatus disposed between a first assembly line for assembling the head stack assembly, and a second assembly line for assembling a head disk assembly including the head stack assembly, and the cleaning apparatus connected directly to at least one of the first assembly line or the second assembly line.

2. A cleaning apparatus according to claim 1 further comprising:
a cleaning unit for cleaning the head stack assembly with a predetermined cleaning liquid;
a drying unit for drying the head stack assembly cleaned by the cleaning unit; and
a carrying device configured to carry the head stack assembly to the cleaning unit and the drying unit.

3. The cleaning apparatus according to claim 2, wherein:
the cleaning unit includes,
a first cleaning unit for spraying a predetermined cleaning liquid on the head stack assembly, and
a second cleaning unit for cleaning the head stack assembly by immersing the head stack assembly in a predetermined cleaning liquid contained in a cleaning tank; and
the carrying device carries the head stack assembly to the first cleaning unit, the second cleaning unit and the drying unit.

4. The cleaning apparatus according to claim 3, wherein the head stack assembly is dried while being carried by the carrying device.

5. The cleaning apparatus according to claim 3 further comprising:
an arm for picking up a head stack assembly delivered from the first assembly line and for vertically moving the picked-up head stack assembly;
wherein the first and the second cleaning unit are disposed-horizontally close to each other, the picked-up head stack assembly is carried by the carrying device and the arm to the first and the second cleaning unit, and the dried head stack assembly is delivered to the second assembly line.

6. The cleaning apparatus according to claim 3 further comprising:
a rotary mechanism for holding at least one of the head stack assemblies and for turning the head stack assembly held by the rotary mechanism about a vertical axis passing a predetermined support position;
wherein the first cleaning unit, the second cleaning unit and the drying unit are arranged along a turning route along which the rotary mechanism turns, and the carrying device carries the head stack assembly to the first cleaning unit, the second cleaning unit and the drying unit by turning the rotary mechanism.

7. The cleaning apparatus according to claim 3, wherein the carrying device includes a belt conveyor for carrying the head stack assembly to the first cleaning unit, the second cleaning unit and the drying unit.

8. The cleaning apparatus according to claim 3 further comprising:
a rotary mechanism for holding the plural head stack assemblies and for turning the head stack assemblies held thereby about a predetermined position in a predetermined direction;
wherein the second cleaning unit cleans the plural head stack assemblies simultaneously by turning the rotary mechanism, and the drying unit dries the plural head stack assemblies simultaneously by turning the rotary mechanism.

9. The cleaning apparatus according to claim 3, wherein a looped carrying route is formed so as to pass the first cleaning unit, the second cleaning unit and the drying unit sequentially.

10. The cleaning apparatus according to claim 2, wherein the predetermined cleaning liquid is an organic solvent.

11. The cleaning apparatus according to claim 10, wherein the organic solvent is a fluorocarbon solvent.

12. The cleaning apparatus according to claim 3, wherein the first cleaning unit pressurizes the predetermined cleaning liquid, and sprays the pressurized cleaning liquid on a predetermined part of the head stack assembly for cleaning.

13. The cleaning apparatus according to claim 3, wherein the cleaning tank is provided with an ultrasonic vibrator, the second cleaning unit cleans the head stack assembly by an ultrasonic cleaning process using the ultrasonic vibrator.

14. The cleaning apparatus according to claim 2, wherein the cleaning unit has an open upper end, and the cleaning apparatus for cleaning a component part of a magnetic disk drive is an open structure.

15. The cleaning apparatus according to claim 2 further comprising a cleaning liquid recovery device configured to recover the predetermined cleaning liquid evaporated in the cleaning apparatus for cleaning a component part of a magnetic disk drive, and replenishing the cleaning unit with the recovered cleaning liquid.

16. A cleaning method of cleaning a component part of a magnetic disk drive, comprising the steps of:
carrying a head stack assembly into a cleaning unit and sealing the cleaning unit;
evacuating the closed cleaning unit;
cleaning in the evacuated cleaning unit, the head stack assembly with a predetermined cleaning liquid containing an organic solvent;
carrying the cleaned head stack assembly into a drying unit and sealing the drying unit;
evacuating the closed drying unit; and
drying the head stack assembly in the evacuated drying unit.
